(19) United States
(12) Patent Application Publication
(10) Pub. No.: US 2026/0009509 A1
(43) Pub. Date: Jan. 8, 2026

(54) LIGHTING APPARATUS

(71) Applicant: LEEDARSON LIGHTING CO.,LTD., Zhangzhou (CN)

(72) Inventors: Huiwu Chen, Zhangzhou (CN); Luyan Zhou, Zhangzhou (CN); Wenhao Lin, Zhangzhou (CN); Hongkui Jiang, Zhangzhou (CN); Tangzhong Liu, Zhangzhou (CN)

(21) Appl. No.: 19/259,228

(22) Filed: Jul. 3, 2025

(30) Foreign Application Priority Data
Jul. 3, 2024 (CN) 202421556142.1

(51) Int. Cl. F21S 4/28; F21V 3/02; F21V 23/00; F21V 23/06; F21V 29/85; F21Y 103/10; F21Y 103/20; F21Y 113/13; F21Y 115/10; H05B 45/20

(52) U.S. Cl. CPC F21S 4/28; F21V 3/02; F21V 23/009; F21V 23/06; F21V 29/85; H05B 45/20; F21Y 2103/10; F21Y 2103/20; F21Y 2113/13; F21Y 2115/10

(57) ABSTRACT

A lighting apparatus includes a bulb shell, a bulb cap, a light source structure and a plurality of color LED modules. The bulb cap encloses a driver configured to convert an external power source into a driving current. The light source structure is disposed within the bulb shell. The light source structure includes multiple elongated light source plates arranged side by side to form a folded polygonal tubular shape. Each of the light source plates extends in a longitudinal direction. Multi-color LED modules are disposed on each light source plate and arranged along the longitudinal direction. At a given longitudinal position, at least two LED modules respectively located on two adjacent light source plates have different colors.

### FIELD

The present invention is related to a lighting apparatus, and more particularly related to a lighting apparatus with a compact structure.

### BACKGROUND

LED technology has revolutionized light device design, becoming the standard for modern illumination due to its unparalleled efficiency and versatility. Unlike traditional light sources such as incandescent or fluorescent bulbs, LEDs (light-emitting diodes) are highly energy-efficient, converting a significant portion of electrical energy into visible light with minimal heat loss. This efficiency not only reduces energy consumption but also translates into lower electricity bills and a smaller environmental footprint, making LEDs an eco-friendly choice for both residential and commercial lighting.

Another advantage of LED technology is its remarkable durability and longevity. LEDs can operate for tens of thousands of hours, far outlasting traditional light bulbs. This extended lifespan reduces the frequency of replacements, which is particularly valuable in hard-to-reach installations or applications requiring constant, reliable lighting. Additionally, the robust construction of LEDs, often encapsulated in solid-state materials, makes them resistant to shock, vibrations, and extreme temperatures, enhancing their reliability in diverse environments.

LEDs also offer unparalleled design flexibility, enabling the creation of innovative lighting devices tailored to specific needs. Their small size and directional light output make them suitable for compact, intricate designs, such as decorative fixtures or task lighting. Furthermore, advancements in LED technology allow for precise control over color, brightness, and beam angle, which designers can leverage to create dynamic lighting effects or meet stringent performance criteria. This versatility is why LEDs are commonly used in applications ranging from architectural lighting to automotive headlights and beyond.

A significant benefit of LEDs is their compatibility with smart lighting systems, which are increasingly in demand for home automation and energy management. LEDs can be seamlessly integrated with dimmers, sensors, and controllers, offering users the ability to adjust brightness, color temperature, or even light patterns through mobile apps or voice commands. This integration not only enhances convenience but also provides data-driven insights into energy usage, allowing for further optimization of lighting systems to save costs and reduce waste.

The environmental benefits of LED technology extend beyond energy efficiency. LEDs are free from toxic elements like mercury, commonly found in fluorescent lights, making them safer for disposal and recycling. Additionally, their lower energy requirements reduce the strain on power grids and decrease greenhouse gas emissions associated with electricity production. As governments and industries worldwide adopt stricter sustainability goals, the widespread implementation of LED lighting plays a crucial role in achieving these targets while maintaining high-quality illumination.

Maintaining compatibility with traditional dimmer designs while incorporating the new technology of LEDs is critical for ensuring a seamless transition to modern lighting systems. Traditional dimmers, commonly found in homes and commercial spaces, were originally designed for incandescent bulbs and operate by cutting the AC waveform to adjust brightness. LED technology, with its distinct electrical properties, often requires specialized circuits or drivers to work with these dimmers effectively. By designing LED lighting systems that remain compatible with existing dimmers, manufacturers can simplify the adoption process for consumers, eliminating the need for costly rewiring or replacement of dimmer infrastructure.

This compatibility is particularly beneficial for retaining the user-friendly features and familiar interfaces of traditional dimmers. Many consumers and professionals rely on the tactile control and simplicity of existing dimmer switches, which are widely installed and understood. By ensuring that LED systems integrate seamlessly with these dimmers, manufacturers can offer a consistent user experience while delivering the energy efficiency, longevity, and advanced features of LED technology. Compatibility also opens up opportunities for mixed-use environments where both traditional and LED lighting may coexist, providing flexibility in upgrading lighting systems incrementally rather than requiring an all-at-once overhaul.

Beyond practicality, fostering compatibility with traditional dimmers paves the way for inventive solutions that bridge old and new technologies. Developing advanced LED controllers that can interpret and respond to the signals from legacy dimmers introduces novel methods of enhancing performance and user satisfaction. For instance, such innovations could include adaptive drivers that dynamically optimize brightness and color consistency in response to dimmer settings or hybrid systems that transition effortlessly between traditional dimmer control and smart lighting functionality. These advancements not only make LED systems more versatile but also ensure that new technology respects and builds upon existing infrastructure, accelerating adoption while opening the door to groundbreaking inventions.

Lighting devices are ubiquitous in modern life, fulfilling essential roles in homes, workplaces, public spaces, and transportation systems. From compact flashlights to intricate chandelier systems, their diversity reflects the wide range of applications and consumer preferences. Each type is tailored for specific needs, such as high-intensity floodlights for outdoor use or ambient LEDs for indoor decor. The demand for these devices is robust, driven by their necessity in creating functional and aesthetic environments. However, this variety poses challenges for manufacturers, retailers, and logistics providers in managing inventory efficiently.

One of the significant challenges in stocking lighting devices is the unpredictability of consumer demand. While certain products, like standard bulbs, may sell consistently, niche items such as specialty lighting for art displays or seasonal decorative lights have more fluctuating demand. This unpredictability complicates forecasting, leading to either overstocking or shortages. Retailers must strike a delicate balance to avoid tying up capital in unsold inventory while ensuring that popular products remain available. As a result, inventory management becomes a critical factor in the lighting industry.

Given the high costs associated with maintaining a large inventory of diverse lighting products, there is a growing emphasis on minimizing stock volume. Retailers and manufacturers are exploring innovative ways to streamline their offerings without compromising consumer satisfaction. Compact, modular lighting solutions that can be expanded or customized during use are gaining traction. These designs reduce storage space requirements while offering flexibility for consumers, making them an appealing choice for both buyers and sellers.

Thickness plays a pivotal role in the design of light devices, as it directly impacts their functionality, aesthetic appeal, and overall usability. A thinner device can lead to enhanced portability and ease of integration into modern applications, such as consumer electronics, automotive lighting, and medical devices. Compactness often becomes a critical selling point, as it aligns with user preferences for sleeker and more space-efficient products. Furthermore, thickness affects thermal management and the structural integrity of the device, necessitating careful consideration during the design process.

From an optical performance perspective, the thickness of light devices influences how light is transmitted, diffused, or reflected within the system. The proper balance between thinness and material properties ensures optimal light distribution, minimizing losses and enhancing brightness and efficiency. For instance, reducing the thickness of optical layers or lenses without compromising their refractive index can improve the device's performance while maintaining a compact form factor. Designers must therefore explore advanced materials and innovative techniques to achieve these performance goals.

Thickness is also a key factor in energy efficiency. Thinner devices often require less power for operation, as they may integrate more efficient light sources, such as LEDs or OLEDs, with minimal energy loss. However, this reduction in thickness must be balanced against the challenges of heat dissipation, which could compromise the device's lifespan or reliability. By carefully managing thickness and incorporating heat-dissipating components or materials, designers can enhance energy efficiency without compromising the device's durability.

Another critical consideration is manufacturing feasibility. While thinner devices offer several advantages, the reduction in thickness can introduce challenges in terms of production processes, material selection, and cost management. Manufacturing thinner components may require more precise machinery, advanced fabrication methods, or specialized materials, which could increase production costs. Balancing these factors while ensuring quality and performance is essential for creating a successful product that meets market demands.

Given these challenges and opportunities, it is beneficial to develop innovative structures that achieve a compact design with reduced thickness. This requires a comprehensive approach that integrates material science, thermal management, optical performance, and cost-effective manufacturing techniques. By addressing these factors in a cohesive manner, designers can create light devices that not only meet modern expectations for slim designs but also ensure durability, functionality, and affordability.

### SUMMARY

In some embodiments, a lighting apparatus includes a bulb shell, a bulb cap, a light source structure and a plurality of color LED modules.

The bulb cap encloses a driver configured to convert an external power source into a driving current.

The light source structure is disposed within the bulb shell. The light source structure includes multiple elongated light source plates arranged side by side to form a folded polygonal tubular shape. Each of the light source plates extends in a longitudinal direction.

Multi-color LED modules are disposed on each light source plate and arranged along the longitudinal direction. At a given longitudinal position, at least two LED modules respectively located on two adjacent light source plates have different colors.

In some embodiments, an inner diameter of the bulb shell is at least 1.5 times greater than a maximum inscribed circle diameter of the folded polygonal tubular light source structure.

In some embodiments, the color LED modules on each light source plate are arranged in a linear array along the longitudinal direction of the light source plate.

In some embodiments, distances between the LED modules on the light source plate are non-uniform.

In some embodiments, the number of LED dies differs among the different color LED modules mounted on the light source plates.

In some embodiments, there are more than three light source plates forming the light source structure.

In some embodiments, the light source structure includes between five and seven light source plates.

In some embodiments, the lighting apparatus may also include a base bracket for fixing the plurality of elongated light source plates.

In some embodiments, the base bracket includes electrodes configured to transmit the driving current to the LED modules on the elongated light source plates.

In some embodiments, each elongated light source plate includes one or more integrated multi-color LED modules,

In some embodiments, the integrated multi-color LED modules have SMD package footprints selected from 1616, 2835, 3030, 3838, 4830, 5050, or similar sized packages, and each package includes either a single chamber or multiple chambers.

In some embodiments, the integrated multi-color LED modules emit light in the following wavelength ranges: blue (B): 420-490 nm, green (G): 500-550 nm, red (R): 600-660 nm, and yellow (Y): 530-600 nm.

In some embodiments, the green, red, and yellow emissions are generated by either direct-emitting LED dies or by blue LED dies combined with wavelength-converting phosphor materials.

In some embodiments, the spectral chromaticity points of the base color channels define a range of achievable mixed light chromaticities.

In some embodiments, a target white or colored light spectrum is generated by combining light from three or four color channels of the integrated multi-color LED modules according to predetermined mixing ratios.

In some embodiments, each elongated light source plate includes a plurality of discrete single-color LED modules arranged in groups to provide multi-color illumination, the groups of discrete LED modules including at least one of RGB, RGGB, RBBG, or RGBY combinations.

In some embodiments, the lighting apparatus may also include a top cover positioned above the plurality of elongated light source plates.

The top cover includes one or more LED modules configured to provide supplementary lighting.

In some embodiments, the top cover is raised toward a central region from a surrounding perimeter.

In some embodiments, an interior of the bulb shell is filled with a thermally conductive gas including helium.

In some embodiments, the bulb shell includes a color diffusion layer configured to scatter light of different wavelengths to different extents.

### BRIEF DESCRIPTION OF DRAWINGS

FIG. 1 illustrates an exploded view of a light bulb embodiment.

FIG. 2 illustrates an unfolded light source plate assembly.

FIG. 3 illustrates a light source structure mounted on an Edison cap.

FIG. 4 illustrates a lighting apparatus emitting light pattern.

FIG. 5 illustrates a light distribution pattern.

FIG. 6 illustrates another lighting apparatus embodiment.

FIG. 7 illustrates another light distribution pattern.

FIG. 8 shows another lighting apparatus embodiment.

FIG. 9 shows a size relation between bulb shell and the inner light source structure.

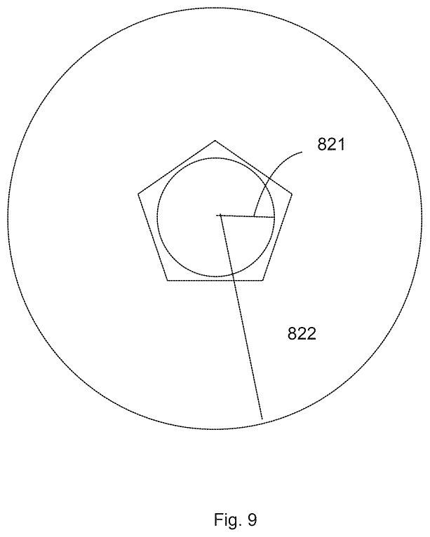

### DETAILED DESCRIPTION

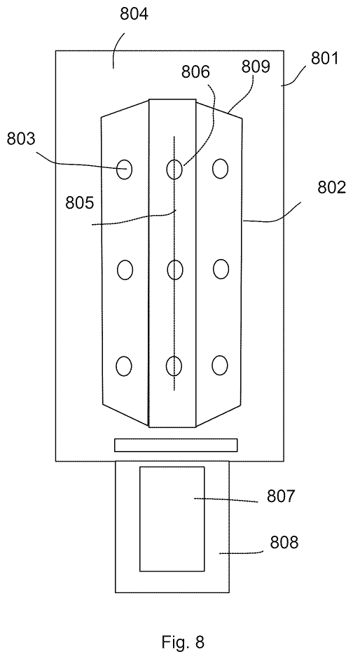

In FIG. 8, a lighting apparatus includes a bulb shell 801, a bulb cap 808, a light source structure 809 and a plurality of color LED modules 803, 806.

The bulb cap 808 encloses a driver 807 configured to convert an external power source into a driving current.

The light source structure 809 is disposed within the bulb shell 801. The light source structure 809 includes multiple elongated light source plates 802 arranged side by side to form a folded polygonal tubular shape. Each of the light source plates 802 extends in a longitudinal direction.

Multi-color LED modules 806 are disposed on each light source plate 802 and arranged along the longitudinal direction 805. At a given longitudinal position, at least two LED modules 803, 806 respectively located on two adjacent light source plates have different colors.

In some embodiments, an inner diameter 822 of the bulb shell is at least 1.5 times greater than a maximum inscribed circle diameter 821 of the folded polygonal tubular light source structure.

In some embodiments, the color LED modules on each light source plate are arranged in a linear array along the longitudinal direction of the light source plate.

In some embodiments, distances between the LED modules on the light source plate are non-uniform.

In some embodiments, the number of LED dies differs among the different color LED modules mounted on the light source plates.

In some embodiments, there are more than three light source plates forming the light source structure.

In some embodiments, the light source structure includes between five and seven light source plates.

In some embodiments, the lighting apparatus may also include a base bracket for fixing the plurality of elongated light source plates.

In some embodiments, the base bracket includes electrodes configured to transmit the driving current to the LED modules on the elongated light source plates.

In some embodiments, each elongated light source plate includes one or more integrated multi-color LED modules,

In some embodiments, the integrated multi-color LED modules have SMD package footprints selected from 1616, 2835, 3030, 3838, 4830, 5050, or similar sized packages, and each package includes either a single chamber or multiple chambers.

In some embodiments, the integrated multi-color LED modules emit light in the following wavelength ranges: blue (B): 420-490 nm, green (G): 500-550 nm, red (R): 600-660 nm, and yellow (Y): 530-600 nm.

In some embodiments, the green, red, and yellow emissions are generated by either direct-emitting LED dies or by blue LED dies combined with wavelength-converting phosphor materials.

In some embodiments, the spectral chromaticity points of the base color channels define a range of achievable mixed light chromaticities.

In some embodiments, a target white or colored light spectrum is generated by combining light from three or four color channels of the integrated multi-color LED modules according to predetermined mixing ratios.

In some embodiments, each elongated light source plate includes a plurality of discrete single-color LED modules arranged in groups to provide multi-color illumination, the groups of discrete LED modules including at least one of RGB, RGGB, RBBG, or RGBY combinations.

In some embodiments, the lighting apparatus may also include a top cover positioned above the plurality of elongated light source plates.

The top cover includes one or more LED modules configured to provide supplementary lighting.

In some embodiments, the top cover is raised toward a central region from a surrounding perimeter.

In some embodiments, an interior of the bulb shell is filled with a thermally conductive gas including helium.

In some embodiments, the bulb shell includes a color diffusion layer configured to scatter light of different wavelengths to different extents.

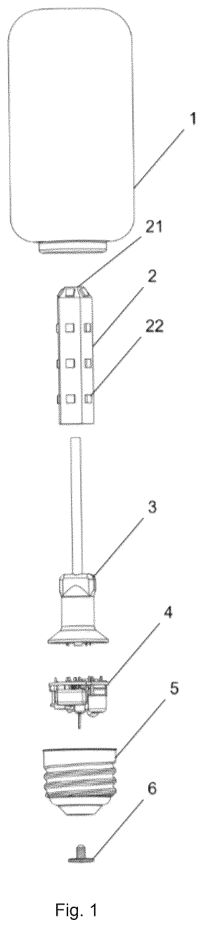

In one embodiment, an exploded view of the LED lamp is shown in FIG. 1. The lamp includes a bulb shell 1, a light source plate 2, a central post 3, a driver assembly 4, a lamp cap 5, and a pin 6. Light source plate 2 is positioned inside bulb shell 1. The ratio of the inner diameter of bulb shell 1 to the maximum inscribed circle diameter of light source plate 2 is 3. Light source plate 2 comprises a plurality of folded facets. A protruding boss 21 is formed at the top of light source plate 2. The central section of light source plate 2 forms a prismatic structure. Each folded facet is mounted with a light source chip 22. Light source plate 2 is fixed to central post 3. Central post 3 is secured to the bottom of bulb shell 1 and connected to driver assembly 4. Driver assembly 4 is housed within lamp cap 5. Lamp cap 5 is located beneath bulb shell 1. Pin 6 is installed at the bottom of lamp cap 5.

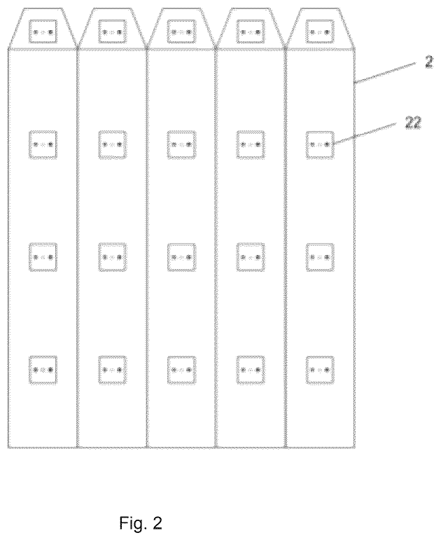

In one embodiment, a schematic view of the flat state of light source plate 2 is shown in FIG. 2. Each folded facet of light source plate 2 includes light source chips 22. Some light source chips 22 contain color LED dies. Light source plate 2 is initially formed as a flat plate composed of multiple foldable rectangles. The plate is pre-cut according to the intended folded shape, and then folded to fit the structure of bulb shell 1 and achieve the desired lighting effect. As shown in FIG. 2, the central section of light source plate 2 may be folded into a prism, and the top may be folded to form boss 21.

Optionally, each light source chip 22 contains three color LED dies arranged along a straight horizontal line. The first color LED die near the edge of a folded facet has a different color than the closest color LED die on the adjacent facet.

Optionally, the central portion of light source plate 2 includes five rectangular folded facets.

Optionally, each rectangular facet carries three light source chips 22.

Optionally, each folded facet forming boss 21 includes one light source chip 22.

Optionally, each light source chip 22 comprises an integrated multi-color LED module in an RGB configuration.

Optionally, the wavelength ranges of the integrated color LED dies are: blue (B): 420-490 nm, green (G): 500-550 nm, red (R): 600-660 nm, and yellow (Y): 530-600 nm. The green, red, and yellow emissions may be generated either directly from monochromatic LED dies or by blue LED dies combined with wavelength-converting phosphor.

Optionally, light source plate 2 is made of a flexible aluminum substrate.

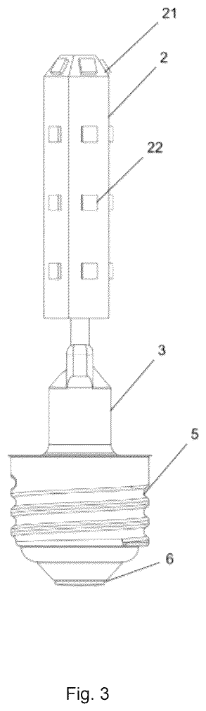

In one embodiment, a structural schematic of the light source plate is shown in FIG. 3. The structure includes light source plate 2, central post 3, lamp cap 5, and pin 6. Light source plate 2 is composed of multiple folded facets. A protruding boss 21 is located at the top of light source plate 2. The central section of light source plate 2 forms a prismatic structure. Each folded facet is equipped with a light source chip 22. Light source plate 2 is mounted on central post 3. Central post 3 is located above lamp cap 5. Pin 6 is mounted at the bottom of lamp cap 5.

Optionally, each rectangular facet includes three light source chips 22.

Optionally, each folded facet forming boss 21 includes one light source chip 22.

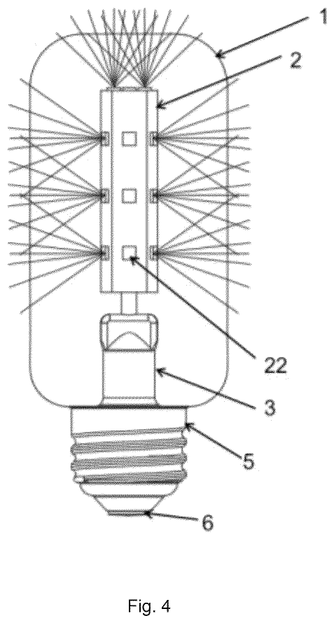

In one embodiment, a schematic view of light distribution for a light source plate with a flat top is shown in FIG. 4. The structure includes bulb shell 1, central post 3, lamp cap 5, pin 6, and a prismatic light source plate 2 with a flat top. The ratio of the inner diameter of bulb shell 1 to the maximum inscribed circle diameter of light source plate 2 is 3. Each folded facet of light source plate 2 is mounted with a light source chip 22. Light source plate 2 is installed on central post 3. Central post 3 is positioned above lamp cap 5. Pin 6 is mounted at the bottom of lamp cap 5. When the top of light source plate 2 is flat, due to the smaller inscribed circle diameter, light emitted from the flat surface cannot reach the top corner (R-angle) of bulb shell 1, resulting in a darker region at the top.

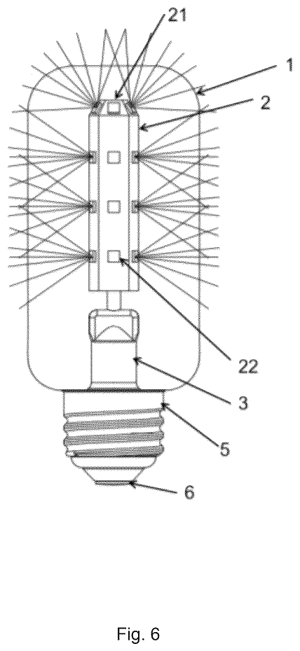

In one embodiment, a schematic view of light distribution for a light source plate with a raised boss is shown in FIG. 6. The structure includes bulb shell 1, central post 3, lamp cap 5, pin 6, and a prismatic light source plate 2 with a raised boss 21 at the top. The ratio of the inner diameter of bulb shell 1 to the inscribed circle diameter of light source plate 2 is 3. Each folded facet is equipped with a light source chip 22. Light source plate 2 is installed on central post 3. Central post 3 is located above lamp cap 5. Pin 6 is mounted at the bottom of lamp cap 5. By adjusting the vertical angle between boss 21 and bulb shell 1 to a suitable value, the issue of low brightness at the top corner of the bulb shell can be improved.

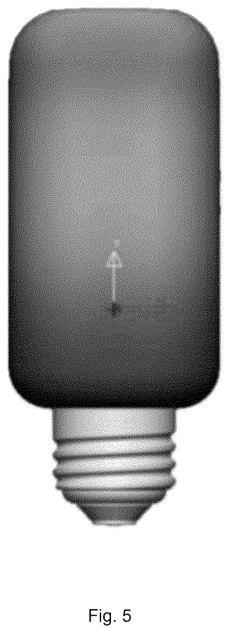

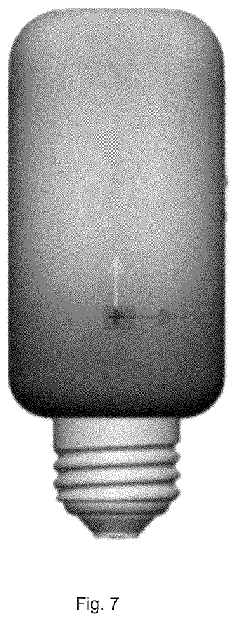

FIG. 5 shows the optical simulation result for the light source plate with a flat top structure as shown in FIG. 4. FIG. 7 shows the simulation result for the light source plate with a raised boss at the top. The brightness at the top region of the LED lamp in FIG. 7 is significantly higher than that in FIG. 5, and the overall brightness and uniformity are improved. From FIG. 5 to FIG. 7, it is evident that forming boss 21 at the top of light source plate 2 enhances top illumination and eliminates dark zones.

In other embodiments, in addition to the configurations described above—where boss 21 or a flat surface is formed at the top of light source plate 2, the center of light source plate 2 includes five rectangular facets with three light source chips 22 per facet, and one light source chip 22 per folded facet of boss 21 in an RGB integrated configuration—other variations may also be used.

Boss 21 may be formed at both the top and bottom of light source plate 2. The central section may include more than three rectangular facets. Each rectangular facet may carry more than three light source chips 22. Each folded facet of boss 21 may include more than one light source chip 22. The integrated color LED configuration may also include RGGB, RBBG, or RGBY.

The ratio of the inner diameter of bulb shell 1 to the inscribed circle diameter of light source plate 2 may be 1.5 or greater, while still achieving the same technical effects of this disclosure. By adjusting this ratio, a proper refraction path and color-mixing distance can be ensured.

Forming boss 21 on light source plate 2 eliminates dark zones within the LED lamp. Through optimized placement of light source chips 22 on light source plate 2 and appropriate layout of color LED dies, the lamp can achieve uniform color mixing and high-quality light output. Furthermore, the sealed space between bulb shell 1 and lamp cap 5 may be filled with a thermally conductive gas to improve the heat dissipation performance of the LED lamp.

In some embodiments, the bulb shell may be configured in various geometric forms, such as a dome, hemisphere, or faceted shape, depending on the optical design. The shell may be constructed from transparent or translucent materials like glass or thermoplastic, and may include surface treatments such as frosting, micro-structuring, or anti-UV coatings. A color diffusion layer may also be applied or embedded within the shell, allowing light of different wavelengths to scatter at different angles, which improves the mixing of multi-color emissions and reduces glare or color shadows.

In some embodiments, the folded polygonal tubular light source structure may include four, five, six, or more light source plates arranged around a central axis. The structure can be assembled using flexible printed circuit substrates or rigid panels with interlocking mechanical features. Each plate may be secured at both ends by a base bracket and an optional top bracket to maintain mechanical alignment and heat dissipation. The polygonal cross-section may be regular or irregular, depending on the desired beam profile and aesthetic appearance.

In some embodiments, the light source plates may carry either integrated multi-color LED modules or groups of discrete single-color LED modules. The discrete modules may be arranged in RGB, RGGB, RBBG, or RGBY groupings and spaced non-uniformly along the longitudinal direction to optimize color blending at different viewing angles. The LED modules may be driven with constant current or PWM signals to enable dynamic control of brightness and color temperature.

In some embodiments, the integrated multi-color LED modules may have SMD footprints selected based on space and thermal constraints. Suitable packages include 1616, 2835, 3030, 3838, 4830, and 5050, with each package containing either a single optical chamber or multiple chambers to isolate colors and enhance control. These modules may house two to four LED dies emitting at different wavelengths, and may be covered with a common or segmented lens to adjust beam shape and diffusion.

In some embodiments, the LED dies used in the modules may emit light in narrow or broad spectral bands. Blue light may range from 420-490 nm, green from 500-550 nm, red from 600-660 nm, and yellow from 530-600 nm. The green, red, and yellow emissions may be achieved either through direct emission from colored LED dies or by combining blue dies with phosphor coatings designed to shift the emitted wavelength via photoluminescence. This flexibility allows for color consistency, energy efficiency, and broad-spectrum tunability.

In some embodiments, the spectral chromaticity points of the LED dies are chosen to form an enclosing triangle or quadrilateral on the CIE 1931 color space diagram, thereby defining the gamut of achievable mixed colors. The apparatus may generate white or colored light output by adjusting the relative intensity of each channel using pre-programmed or sensor-driven algorithms. Color temperature, CRI (Color Rendering Index), and saturation can be adjusted dynamically to suit different ambient or application needs.

In some embodiments, the lighting apparatus includes a base bracket that mechanically supports the light source plates and also serves as an electrical interface. The bracket may include printed circuit features, copper traces, or metal electrodes that deliver the driving current from the driver module to the LED modules. Heat sinks or thermal vias may be integrated into the base bracket to conduct heat away from the plates and maintain LED junction temperature within acceptable limits.

In some embodiments, the lighting apparatus includes a top cover positioned above the folded light source structure. The top cover may carry additional LED modules used for supplemental illumination, particularly to fill the upper zone of the bulb shell and eliminate dark areas. The top cover may be flat or shaped to rise toward a central apex, creating a dome or boss structure that improves optical coverage at steep angles near the top of the lamp.

In some embodiments, the interior volume of the bulb shell is filled with a thermally conductive gas such as helium or a helium-oxygen mixture. The gas filling improves heat transfer from the LED modules and circuit components to the outer shell by reducing thermal resistance compared to air. The shell may be hermetically sealed to retain the gas and prevent moisture ingress, enhancing reliability and extending product life.

In some embodiments, the color LED modules on adjacent light source plates are selected to have different dominant colors at corresponding longitudinal positions. This spatial offset in color distribution can promote color blending across angular zones and minimize visible segmentation in emitted light. By carefully controlling LED spacing, die count, and layout symmetry, the apparatus can achieve high color uniformity and luminous efficacy while maintaining a compact, manufacturable design.

In some embodiments, the light source plates may be shaped with curvature or angular bends rather than being flat, allowing the folded polygonal structure to approximate a cylindrical or spherical geometry. These curved or chamfered edges can help distribute light more evenly across the bulb shell, reduce harsh shadows, and improve the visual comfort of the emitted light. Such geometries may also be beneficial in compact designs where space efficiency and omni-directional output are desired.

In some embodiments, each light source plate may be independently detachable or replaceable. This modular approach enables selective replacement of failed LED modules or allows users to customize the color configuration based on lighting needs. The modular plates may include quick-connect terminals or plug-in headers that align with power distribution traces on the base bracket, allowing for tool-less installation and repair.

In some embodiments, the light source structure may include reflective surfaces, diffusive films, or optical baffles positioned between adjacent light source plates. These optical elements can shape the light distribution, block direct line-of-sight to high-intensity regions, or enhance the mixing of light between different color channels. The reflectors may be specular or diffuse, made from metalized polymers, coated aluminum, or ceramic films.

In some embodiments, the driver housed within the bulb cap may support dimming, color tuning, and programmable lighting profiles. The driver may include a microcontroller, memory, and communication interface such as Bluetooth, Zigbee, or DALI, enabling remote control via mobile devices or integration with smart lighting networks. Advanced drivers may also support power factor correction, surge protection, and thermal derating logic.

In some embodiments, the bulb shell may incorporate decorative or branding features without compromising optical performance. For example, a frosted gradient or partial tint may be applied to certain zones to evoke a vintage filament appearance or add ambient styling. Logos, patterns, or alignment markers may be laser-etched or molded into the shell material for aesthetic or functional purposes.

In some embodiments, the LED modules may include onboard sensors such as ambient light detectors, proximity sensors, or temperature sensors. These sensors can inform lighting control algorithms to optimize brightness, color temperature, or power usage in real time. For example, the LED lamp may dim automatically in a bright environment or shift to a warmer tone during nighttime hours.

In some embodiments, the LED modules may be coated with a protective conformal layer or encapsulant to enhance moisture resistance and durability. The encapsulant may be optically clear silicone or polyurethane, optionally with UV blockers or anti-yellowing agents. In outdoor or industrial environments, this coating can provide additional protection against dust, vibration, or chemical exposure.

In some embodiments, the number of color channels in each LED module may exceed four. For instance, modules may include cyan, amber, or lime channels in addition to RGB or RGBY to expand the color rendering capabilities and achieve higher fidelity white light. These extended-spectrum modules can be especially useful in applications requiring high CRI or tunable spectrum output for plant growth, retail displays, or museum lighting.

In some embodiments, the folded light source structure may include edge-lit configurations, where LED modules are mounted only at the edges of the plates, and light is guided through the plate material via total internal reflection. This approach may use transparent or translucent substrates embedded with scattering centers to emit light uniformly across the surface, reducing the number of LED modules required while maintaining uniform illumination.

In some embodiments, the light source plates or supporting structures may include embedded identification or configuration codes, such as RFID tags or QR codes. These can be scanned during assembly or service to identify model type, manufacturing batch, or component status. In automated production lines, such identifiers can support traceability, quality control, and firmware configuration for smart lighting systems.

In some embodiments, the elongated light source plates may have perforations, ventilation holes, or microchannels to enhance airflow and improve passive cooling. These structural features may be aligned along the longitudinal direction or around the edges of each plate to direct heat toward the bulb shell. The perforations may also help reduce overall material weight, improve flexibility in foldable designs, and support acoustic transparency in applications combining lighting and audio output.

In some embodiments, the folded light source structure may incorporate color zones arranged for functional lighting effects. For instance, certain plates or plate sections may be configured with warm-white LEDs, while others are fitted with cool-white or colored LEDs. This zoning strategy enables mixed-purpose illumination, such as simultaneous ambient and accent lighting, or dynamic transitions from daylight to mood lighting in residential or commercial settings.

In some embodiments, each light source plate may include integrated optics directly molded onto or bonded above the LED modules. These optics may include collimating lenses, micro-lens arrays, Fresnel lenses, or asymmetric beam shapers to control the output angle, intensity distribution, or glare characteristics. The integration of optics at the module level allows compact designs and minimizes the need for external reflectors or diffusers.

In some embodiments, the entire folded light source structure may be rotatable or adjustable relative to the bulb shell or base. A mechanical pivot or screw mechanism may allow users to reorient the direction of maximum brightness. This feature can be useful in task lighting or directional fixtures, enabling users to fine-tune the illumination direction without rotating the entire bulb.

In some embodiments, the lighting apparatus may be designed for compatibility with dual-mode operation, such as mains AC input and low-voltage DC input. The driver may include automatic sensing and switching circuitry to adapt to either power source. This feature allows the lamp to be used in traditional fixtures or connected to battery-backed emergency systems, solar installations, or automotive lighting setups.

In some embodiments, the folded light source plates may be spaced apart with deliberate gaps, forming an open lattice structure. This design may help distribute heat more effectively and improve the light blending from adjacent modules. The spacing may also be used to accommodate other internal components, such as reflectors, light sensors, wireless antennas, or internal fan modules.

In some embodiments, the surface of the light source plates may include printed or embossed reference markings to aid assembly, orientation, or inspection. These may include serial numbers, alignment notches, thermal indicators, or barcodes. During production or servicing, such markings enable easy visual checks and reduce the chance of incorrect installation or orientation.

In some embodiments, the lighting apparatus may include a translucent internal diffuser positioned concentrically around or above the folded light source structure. This inner diffuser may be made of polycarbonate, PET, or silicone and serve to blend multiple color sources before they exit the outer bulb shell. The use of a secondary diffusion layer enhances uniformity and reduces color fringes, particularly in high-CRI or multi-channel configurations.

In some embodiments, the base bracket used to mount the light source plates may be made of materials with both structural and thermal advantages, such as die-cast aluminum, magnesium alloy, or ceramic composites. The base bracket may feature integrated mounting clips, wire routing channels, or heat pipes that extend toward the bulb shell to promote efficient thermal management and simplify assembly.

In some embodiments, the driving current delivered to the LED modules may be independently controlled per plate or per color channel. The driver may use multi-channel current regulation circuits or matrix-addressed current sources to support selective dimming, dynamic light patterns, or advanced scene programming. This level of control supports adaptive lighting scenarios such as circadian rhythm adjustment, dynamic color transitions, or synchronized effects across multiple lighting units.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A lighting apparatus comprising:
a bulb shell;
a bulb cap enclosing a driver configured to convert an external power source into a driving current;
a light source structure disposed within the bulb shell, the light source structure comprising a plurality of elongated light source plates arranged side by side to form a folded polygonal tubular shape, each of the light source plates extending in a longitudinal direction; and
a plurality of color LED modules disposed on each light source plate and arranged along the longitudinal direction, wherein, at a given longitudinal position, at least two LED modules respectively located on two adjacent light source plates have different colors.

2. The lighting apparatus of claim 1, wherein an inner diameter of the bulb shell is at least 1.5 times greater than a maximum inscribed circle diameter of the folded polygonal tubular light source structure.

3. The lighting apparatus of claim 1, wherein the color LED modules on each light source plate are arranged in a linear array along the longitudinal direction of the light source plate.

4. The lighting apparatus of claim 3, wherein distances between the LED modules on the light source plate are non-uniform.

5. The lighting apparatus of claim 3, wherein the number of LED dies differs among the different color LED modules mounted on the light source plates.

6. The lighting apparatus of claim 1, wherein there are more than three light source plates forming the light source structure.

7. The lighting apparatus of claim 6, wherein the light source structure comprises between five and seven light source plates.

8. The lighting apparatus of claim 1, further comprising a base bracket for fixing the plurality of elongated light source plates.

9. The lighting apparatus of claim 8, wherein the base bracket includes electrodes configured to transmit the driving current to the LED modules on the elongated light source plates.

10. The lighting apparatus of claim 1, wherein each elongated light source plate includes one or more integrated multi-color LED modules.

11. The lighting apparatus of claim 10, wherein the integrated multi-color LED modules have SMD package footprints selected from 1616, 2835, 3030, 3838, 4830, 5050, or similar sized packages, and each package comprises either a single chamber or multiple chambers.

12. The lighting apparatus of claim 10, wherein the integrated multi-color LED modules emit light in the following wavelength ranges: blue (B): 420-490 nm, green (G): 500-550 nm, red (R): 600-660 nm, and yellow (Y): 530-600 nm.

13. The lighting apparatus of claim 10, wherein the green, red, and yellow emissions are generated by either direct-emitting LED dies or by blue LED dies combined with wavelength-converting phosphor materials.

14. The lighting apparatus of claim 10, wherein the spectral chromaticity points of the base color channels define a range of achievable mixed light chromaticities.

15. The lighting apparatus of claim 10, wherein a target white or colored light spectrum is generated by combining light from three or four color channels of the integrated multi-color LED modules according to predetermined mixing ratios.

16. The lighting apparatus of claim 1, wherein each elongated light source plate includes a plurality of discrete single-color LED modules arranged in groups to provide multi-color illumination, the groups of discrete LED modules including at least one of RGB, RGGB, RBBG, or RGBY combinations.

17. The lighting apparatus of claim 1, further comprising a top cover positioned above the plurality of elongated light source plates, wherein the top cover includes one or more LED modules configured to provide supplementary lighting.

18. The lighting apparatus of claim 17, wherein the top cover is raised toward a central region from a surrounding perimeter.

19. The lighting apparatus of claim 1, wherein an interior of the bulb shell is filled with a thermally conductive gas comprising helium.

20. The lighting apparatus of claim 1, wherein the bulb shell comprises a color diffusion layer configured to scatter light of different wavelengths to different extents.
